(19) United States
(12) Patent Application Publication
(10) Pub. No.: US 2020/0270785 A1
(43) Pub. Date: Aug. 27, 2020

(54) THERMAL INSULATION FLOCCULUS MATERIAL AND PREPARATION METHOD THEREOF AND THERMAL INSULATION PRODUCT

(71) Applicant: 3M INNOVATIVE PROPERTIES COMPANY, St. Paul, MN (US)

(72) Inventors: Weili Hu, Shanghai (CN); Guo Tong Zhao, Shanghai (CN)

(21) Appl. No.: 16/063,948

(22) PCT Filed: Dec. 23, 2016
(86) PCT No.: PCT/US2016/068477

§ 371 Date: Jun. 19, 2018

(30) Foreign Application Priority Data
Dec. 30, 2015 (CN) 201511020914.5

(51) Int. Cl. D04H 1/413; D04H 1/54; B32B 5/02; B32B 5/16; B32B 5/26; B32B 7/12; B68G 1/00

(52) U.S. Cl. CPC D04H 1/413; D04H 1/54; B32B 5/022; B32B 5/16; B32B 5/26; B32B 7/12; B68G 2001/005; B32B 2250/20; B32B 2250/40; B32B 2479/00; B32B 2437/02; B32B 2437/04; B68G 1/00

(57) ABSTRACT

The present disclosure provides a thermal insulation flocculus material and a preparation method thereof and a thermal insulation product, and pertains to the field of thermal insulation flocculus materials. In one exemplary embodiment, the thermal insulation flocculus material of the present disclosure includes multiple overlapped single fiber meshes; and a spherical fiber assembly at least distributed between a part of adjacent single fiber meshes. In some embodiments, the thermal insulation flocculus material has combination properties such as excellent filling power, compression-resilience property, thermal insulation property and/or wash durability or the like.

### TECHNICAL FIELD

The present disclosure generally relates to thermal insulation flocculus materials, thermal insulation products, and/or methods of making each.

### SUMMARY

The present disclosure generally relates to thermal insulation flocculus materials, thermal insulation products, and/or methods of making each. In some embodiments, the thermal insulation materials and/or products have excellent filling power, compression-resilience property, thermal insulation property and wash durability.

In some embodiments, the thermal insulation flocculus material of the present disclosure includes: multiple overlapped single fiber meshes; and a spherical fiber assembly at least distributed between a part of adjacent single fiber meshes. In some embodiments, multiple adjacent single fiber meshes constitute a multi-layer single fiber mesh, where all the spherical fiber assemblies are distributed between adjacent multi-layer single fiber meshes; and each of the multi-layer single fiber meshes has a grammage ranged between about 20 g/m² and about 150 g/m².

In some embodiments of the present disclosure, a method for preparing thermal insulation flocculus material includes: applying a spherical fiber assembly to a first single fiber mesh; and compositing at least a second single fiber mesh onto the first single fiber mesh to which the spherical fiber assembly is applied.

In some embodiments of the present disclosure, a thermal insulation product is provided with the thermal insulation flocculus material. The thermal insulation product has excellent filling power, compression-resilience property, thermal insulation property and/or wash durability. In some embodiments, the thermal insulation product includes: a cladding body, configured to define enclosed internal space; and thermal insulation flocculus material disposed in the enclosed internal space as defined by the cladding body, wherein the thermal insulation flocculus material comprises multiple overlapped single fiber meshes, and a spherical fiber assembly at least distributed between a part of adjacent single fiber meshes.

### BRIEF DESCRIPTION OF THE DRAWINGS

FIG. 1 is a schematic diagram of a sectional structure of a thermal insulation flocculus material according to an embodiment of the present disclosure;

FIG. 2 is a comparison chart of test results of filling power of thermal insulation flocculus materials in a comparative example and embodiments of the present disclosure;

FIG. 3 is a comparison chart of test results of thermal insulation property of thermal insulation flocculus materials in a comparative example and embodiments of the present disclosure;

FIG. 4 is a comparison chart of test results of compression resilience ratio of thermal insulation flocculus materials in a comparative example and embodiments of the present disclosure; and

FIG. 5 is a comparison chart of test results of thermal resistance retention rate of thermal insulation flocculus materials in a comparative example and embodiments of the present disclosure.

### DETAILED DESCRIPTION

In order that those skilled in the art better understand the technical solution of the present disclosure, the following further describes in detail the present disclosure with reference to the accompanying drawings and embodiments.

Phraseology Interpretation

In the present disclosure, meanings of the following terms or descriptive approaches are as below:

Description of “between A and B” or “from A to B” includes a value of A, a value of B, and any value that is greater than A and smaller than B. For example, “between 1 and 10” includes, 1, 10 and any value that is greater than 1 and smaller than 10, for example, 2, 3, 4, 5, 6, 7, 8, 9, 2.3, 3.516, 5.26, 7.1 and 9.999, etc.

Description of “A is approximate to B” or “A is essentially equal to B” or “A is substantially equal to B” means that A conforms to B on the whole, allowing unavoidable small difference between A and B, and the difference being minor with respect to the dimension of B.

“Material dosage” in the present disclosure, material dosage or dosage ratio refers to weight or weight ratio unless specifically stated.

“Weight percentage of A in B” refers to percentage of A in B when A belongs to a part of B and weight of B is denoted by 100%.

“Weight ratio of A to B” refers to proportional relationship between weight of A and weight of B when A is different from other constituents of B.

“Fiber” refers to a continuous or discontinuous filament, the dimension of which in the length direction is greater than that thereof in any direction in a cross section. “Single fiber mesh” refers to a single-layer thin fiber mesh consisting of a single fiber.

“Multi-layer single fiber mesh” refers to a multi-layer fiber mesh consisting of multiple adjacent and overlapped single fiber meshes.

“Spherical fiber assembly” refers to bulk material consisting of a great number of “fiber balls”, and fiber balls are basically spherical materials formed by winding fibers. “Denier (D)” is a unit of fiber fineness, representing weight in grams of a 9,000-meter-long fiber at the conventional moisture regain.

“Clo value” is a parameter for evaluating the thermal insulation property of a material, which in essence is a thermal resistance value, the larger the value is, the better the thermal insulation property is. When a person sits quietly or engages in mild mental labor (with a calorific power of 209.2 kJ/m²·h) at 21° C. in a relative humidity smaller than 50% at an air speed not more than 0.1 m/s and feels comfortable, the Clo value for the clothes which the person wears is defined as 1.

Thermal Insulation Flocculus Material

An embodiment of the present disclosure provides a thermal insulation flocculus material, which includes: multiple overlapped single fiber meshes; and a spherical fiber assembly at least distributed between a part of adjacent single fiber meshes.

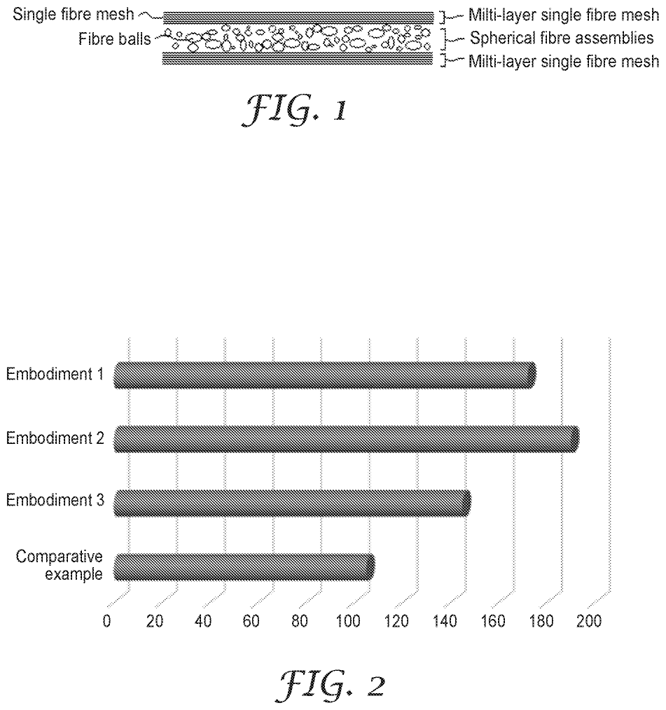

As shown in FIG. 1, the thermal insulation flocculus material in the first embodiment of the present disclosure includes multiple single fiber meshes, and a spherical fiber assembly sandwiched between at least a part of adjacent single fiber meshes.

In the present disclosure, it is creatively found that by means of a spherical fiber assembly disposed between single fiber meshes, a product obtained may have advantages of both the thermal insulation flocculus material and the thermal insulation filling material, having excellent filling power, compression-resilience property, thermal insulation property and wash durability.

In some embodiments, it is preferred to have a weight ratio of the single fiber mesh to the spherical fiber assembly is ranged between about 20:80 and about 80:20, and more preferably between about 40:60 and about 60:40, and the most preferably 50:50.

In some embodiments, it is preferred to have a single fiber mesh and a spherical fiber assembly, the weight percentage of the single fiber mesh is preferably from 20% to 80%, more preferably from 40% to 40%, and further preferably 50%. Correspondingly, the weight percentage of the spherical fiber assembly is preferably from 20% to 80%, more preferably from 40% to 40%, and further preferably 50%.

In some embodiments, it is preferred to have multiple adjacent single fiber meshes constitute a multi-layer single fiber mesh, where all the spherical fiber assemblies are distributed between adjacent multi-layer single fiber meshes; and each of the multi-layer single fiber meshes has a grammage ranged between about 20 g/m² and 150 g/m², and more preferably has a grammage ranged between about 40 g/m² and 100 g/m².

In the thermal insulation flocculus material of the present disclosure, the spherical fiber assembly is disposed between adjacent single fiber meshes. However, it is apparent that a separate single fiber mesh is low in intensity, and poor in clamping and positioning the spherical fiber assembly. Therefore, as shown in FIG. 1, multiple single fiber meshes among which no spherical fiber assembly is disposed may be arranged continuously to constitute a “multi-layer single fiber mesh” having a larger thickness and intensity, then a spherical fiber assembly is disposed between two adjacent multi-layer single fiber meshes (of course, the spherical fiber assembly is still positioned between adjacent single fiber meshes). In this way, at least one side of any single fiber mesh in the thermal insulation flocculus material is adjacent to another single fiber mesh. If the quantity of single fiber meshes in each multi-layer single fiber mesh is too small, little difference is between single fiber meshes and the multi-layer single fiber mesh in nature. However, if the quantity of single fiber meshes in each multi-layer single fiber mesh is too large, it is unable to embody the function of the spherical fiber assembly. It has been discovered that it is relatively appropriate when the grammage of each multi-layer single fiber mesh is within the foregoing range.

Preferably, the spherical fiber assembly positioned between two adjacent single fiber meshes has a grammage ranged between about 20 g/m² and about 200 g/m², and more preferably has a grammage ranged between about 40 g/m² and about 160 g/m².

If the quantity of spherical fiber assemblies (or, “a layer of” spherical fiber assemblies) between two adjacent single fiber meshes is too small, the optimal workings of the disclosure may not be achieved. It is difficult to be positioned if the quantity thereof is too large. Thus, it has been discovered that it is relatively appropriate when the grammage of the spherical fiber assembly between two adjacent single fiber meshes is within the foregoing range.

As a preferred manner of the embodiments of the present disclosure, the thermal insulation flocculus material may merely consist, as shown in FIG. 1, of two multi-layer single fiber meshes and one layer of spherical fiber assemblies. It should be understood that it is also practicable if the thermal insulation flocculus material includes more layers of spherical fiber assemblies and more single fiber meshes (or multi-layer single fiber meshes).

The grammage of the whole thermal insulation flocculus material depends on the quantity (number of layers) of the single fiber meshes and the spherical fiber assemblies and on the grammage of each layer structure, and is set according to specific using environment, preferably ranged between 60 g/m² and 600 g/m² generally, and more preferably between 80 g/m² and 400 g/m².

Preferably, the spherical fiber assembly has a particle size ranged between about 3 mm and about 15 mm. In other words, in the spherical fiber assembly, the particle size of each separate “fiber ball” is preferably within the foregoing range. Of course, regarding the same spherical fiber assembly, particle sizes of different fiber balls may be different or vary.

In some embodiments, at least a part of fibers constituting the single fiber mesh are low-melting-point fibers; and at least a part of fibers constituting the spherical fiber assembly are low-melting-point fibers. In some embodiments, the melting point of the low-melting-point fibers is ranged between about 100° C. and about 140° C.

Among fibrous raw materials constituting the single fiber mesh and the spherical fiber assembly, preferably at least a part of the fibrous raw materials have a lower melting point. These fibers are known in the art, and are referred to as “low-melting-point fibers”. The low-melting-point fibers more specifically refers to fibers whose melting points are ranged from 100° C. to 140° C., including but not limited to: low-melting-point polyster fiber, low-melting-point polypropylene fiber, and low-melting-point polyethylene fiber or the like, or being sheath core fiber, for example, low-melting-point sheath core polyster fiber.

In addition to low-melting-point fibers, the fibrous raw materials may also include other fibers (i.e., non-low-melting-point fibers), and types of these fibers are not particularly limited, including but not limited to: natural fiber, synthetic fiber, regenerated fiber or the like, as long as their melting points conform to the requirement (apparently higher than the melting points of low-melting-point fibers).

Preferably, the thermal insulation flocculus material is subjected to thermal processing and setting treatment.

The thermal insulation flocculus material in the embodiments of the present disclosure consists of multiple single fiber meshes and a large number of spherical fiber assemblies.

However, interaction force among these structures is very weak, and thus they may be prone to dislocation or separation, etc. For this reason, low-melting-point fibers may be used in fibrous raw materials of the single fiber meshes and the spherical fiber assemblies, and the thermal insulation flocculus material is subjected to thermal processing and setting treatment, so that the low-melting-point fibers are partly melted, various structures are “bonded” together, and the thermal insulation flocculus material having a stable form is formed. The thermal processing and setting treatment lasts for 5-15 minutes at a temperature of from 120° C. to 150° C., and the concrete treatment temperature and time depend on the low-melting-point fibers used, which is not elaborated herein as the thermal processing and setting treatment itself is a known art. Of course, the thermal insulation flocculus material does not contain low-melting-point fibers, it may also be subjected to thermal processing and setting treatment, what is needed is nothing but a higher heating temperature.

Preferably, the weight percentage of the low-melting-point fibers among the fibers constituting the single fiber mesh is ranged between about 5% and about 20%; and the weight percentage of the low-melting-point fibers among the fibers constituting the spherical fiber assembly is ranged between about 5% and about 20%.

In other words, among fibrous raw materials constituting the single fiber meshes and the spherical fiber assemblies, low-melting-point fibers preferably account for 5%-20%. Correspondingly, other fibers (non-low-melting-point fibers) excluding the low-melting-point fibers are the remainders. Use of such low-melting-point fibers may ensure a good setting effect.

Preferably, the low-melting-point fibers have a length ranged between about 20 mm and about 90 mm, and preferably have a fineness ranged between about 1.5 D and about 7 D.

Correspondingly, other fibers excluding the low-melting-point fibers have a length ranged between about 15 mm and about 75 mm, and preferably have a fineness ranged between about 0.2 D and about 15 D.

In other words, among fibers constituting the single fiber meshes and the spherical fiber assemblies, preferably the lengths and finenesses of the low-melting-point fibers and the non-low-melting-point fibers are respectively within the foregoing range, thus the thermal insulation flocculus material may obtain better performance.

It should be understood that among the single fiber meshes and the spherical fiber assemblies of the same thermal insulation flocculus material, fibrous raw materials used may be different, i.e., among the fibrous raw materials of the single fiber meshes and the fibrous raw materials of the spherical fiber assemblies, varieties, contents, lengths and finenesses or the like of fibers may be different. Further, the low-melting-point fibers (or the non-low-melting-point fibers) may be formed by mixing various different specific fibrous raw materials.

Preferably, the thermal insulation flocculus material is subjected to surface glue spraying treatment.

In other words, glue may be sprayed and solidified (glue spraying treatment) on the surface of the thermal insulation flocculus material in the embodiments of the present disclosure. In this way, burrs or the like on the surface of the thermal insulation flocculus material are concealed, and a glabrous surface is obtained. Generally available glue includes but is not limited to: acrylate copolymer emulsion, polyvinyl acetate emulsion, and vinyl acetate-acrylate copolymer emulsion, etc. Glue dosage generally is, calculated in solid content, ranged from 2 g/m² to 15 g/m², i.e., glue applied to the thermal insulation flocculus material per square meter has 2 g-15 g of solid matter. It is not elaborated herein as the glue spraying treatment itself is a known art.

The glue spraying treatment also includes a step of heating to dry the glue. Therefore, the glue spraying treatment and the thermal processing and setting treatment (a treatment to melt the low-melting-point fibers) may be conducted simultaneously, i.e., it is heated after glue is sprayed, and the glue is dried at the same time when the low-melting-point fibers are melted.

It should be understood that although it is described hereinabove the single fiber meshes and the spherical fiber assemblies necessarily included in the thermal insulation flocculus material, it is also practicable if the thermal insulation flocculus material further includes other known constituents or additives, etc.

Method for Preparing Thermal Insulation Flocculus Material

An embodiment of the present disclosure provides a method for preparing thermal insulation flocculus material, which includes: applying a spherical fiber assembly to a first single fiber mesh; and compositing at least a second single fiber mesh onto the first single fiber mesh to which the spherical fiber assembly is applied.

The method for preparing thermal insulation flocculus material in the embodiments of the present disclosure includes: applying a spherical fiber assembly to a single fiber mesh (including a multi-layer single fiber mesh); and compositing another single fiber mesh (including a multi-layer single fiber mesh) onto the spherical fiber assembly, thereby forming a structure of the spherical fiber assembly sandwiched between two adjacent single fiber meshes.

Specifically, a multi-layer single fiber mesh (the single fiber mesh at the uppermost layer being the first single fiber mesh) is laid by using a lapping machine, then a layer of spherical fiber assemblies is interspersed thereon, and finally another multi-layer single fiber mesh (the single fiber mesh at the lowermost layer being the second single fiber mesh) is laid on the spherical fiber assembly by using the lapping machine, thereby forming the thermal insulation flocculus material.

If the thermal insulation flocculus material further has a multilayer structure, what is needed is nothing but to continue the step of interspersing spherical fiber assemblies on the multi-layer single fiber mesh at the uppermost layer and the step of laying a multi-layer single fiber mesh, which is not elaborated herein.

Thermal Insulation Product

An embodiment of the present disclosure provides a thermal insulation product which is provided with thermal insulation flocculus material, including: a cladding body, configured to define enclosed internal space; and thermal insulation flocculus material disposed in the enclosed internal space as defined by the cladding body, wherein the thermal insulation flocculus material comprises multiple overlapped single fiber meshes, and a spherical fiber assembly at least distributed between a part of adjacent single fiber meshes.

The thermal insulation flocculus material may be disposed in the enclosed cladding structure, thereby forming a practically applicable thermal insulation product. Preferably, the cladding body is a flexible cladding body. The foregoing cladding body may be flexible material such as shell fabric or leather or the like, and thus can form enclosed internal space by means of sewing technology or the like. Therefore, the thermal insulation product is also flexible, and may deform to a certain extent as a user needs, thereby providing the user with more comfortable use experience.

Preferably, the foregoing thermal insulation product may be bedclothes, clothes or the like, a specific example thereof includes but is not limited to: shoes, a cap, clothes (including a coat, trousers, underclothes, overclothes or the like), a pillow, a quilt, a mattress, a sleeping bag, etc.

### EXAMPLES

The following examples provide a more detailed description of the embodiments of the present disclosure.

1. Raw M5aterials

Specific circumstances regarding raw materials used in the embodiments of the present disclosure and a comparative example are as below:

Low-melting-point fiber 1: low-melting-point polyster fiber, with a length of 51 mm, a fineness of 2D and a melting point of 110° C., purchased from Sichuan Huvis Chemical Fiber Co., Ltd.

Low-melting-point fiber 2: low-melting-point ES polyethylene/polypropylene fiber, with a length of 51 mm and a fineness of 2D, purchased from Guangzhou ES Fiber Co., Ltd.

Low-melting-point fiber 3: low-melting-point polyster fiber, with a length of 51 mm and a fineness of 4D, purchased from Sichuan Huvis Chemical Fiber Co., Ltd.

Non-low-melting-point fiber 1: solid polyster fiber, with a length of 38 mm and a fineness of 0.8D, purchased from Sinopec Yizheng Chemical Fiber Company Limited (YCF).

Non-low-melting-point fiber 2: crimp hollow synthetic fiber, with a length of 64 mm and a fineness of 7D, purchased from Sinopec Yizheng Chemical Fiber Company Limited (YCF).

Non-low-melting-point fiber 3: solid polyster fiber, with a length of 51 mm and a fineness of 2D, purchased from Far Eastern Industries (shanghai) Co., Ltd. Non-low-melting-point fiber 4: crimp hollow synthetic fiber, with a length of 64 mm and a fineness of 3D, purchased from Far Eastern Industries (shanghai) Co., Ltd.

Glue 1: YH-1 type glue, purchased from Yixing Jindeli Chemical Co., Ltd. Glue 2: EXP3267 type acrylate copolymer emulsion glue, purchased from Rohm & Haas.

Glue 3: VAE707 type polyvinyl acetate emulsion glue, purchased from Beijing Uninm New Material Co., Ltd.

2. Performance Test Methods

In order to evaluate the performance of thermal insulation flocculus materials in various embodiments and the comparative example, it is necessary to conduct a series of performance tests, and specific test methods are as below:

1) Filling Power

The filling power of a sample is tested according to Article 6.10 of Standard FZ/T64006, specifically including:

Selecting a 10 cm×10 cm (i.e., an area of 100 cm²) sample, pressurizing it at 0.02 kPa, measuring an initial thickness t0(mm) after 10s, and weighing a weight m (accurate to 0.001 g) of the sample, thereby obtaining a value of filling power (cm³/g)=10×t0/m.

2) Thermal insulation property (thermogravimetric efficiency)

vacuum-packing the sample and placing it for 2 weeks, unpacking and placing the sample for at least 24 h in a stress-free state to recover the sample, then testing a Clo value in accordance with Standard ASTM F1868 Part C (i.e., Standard GB/T 11048), specifically including:

selecting a 50 cm×50 cm sample and spreading it on a test board having an area of A, then heating the test board with a heating power H; after the temperature becomes stable, recording the surface temperature Tm of the test board and the ambient temperature (air temperature) Ta; and calculating a thermal resistance R, R=[A×(Tm−Ta)/(H−ΔH)]−R₀, where ΔH is a predetermined heating power correction, and Ro is a predetermined thermal resistance correction; measuring thrice and taking an average value, and correspondingly, obtaining a Clo value=6.451R.

3) Compression-Resilience Property

The compression resilience ratio of a sample is tested according to Article 6.10 of Standard FZ/T64006, specifically including:

selecting a 10 cm×10 cm (i.e., an area of 100 cm²) sample, applying a 0.02 kPa light pressure to it, measuring an initial thickness t0 (mm) after 10 s; increasing the pressure and applying a 1 kPa heavy pressure to it, and measuring a thickness th (mm) under pressure after 1 minute; removing the pressure, recovering for 1 minute and then applying a light pressure, measuring a recovery thickness tr (mm) after 10s; and calculating the compression resilience ratio (%)=100%×(tr−th)/(t0−th).

4) Wash Durability

washing the sample ten times according to Standard GB/T8629-2001:7A, where washing is conducted by a FOM71 CLS type horizontal drum washing machine (purchased from

Electrolux Corporation), where in various steps it is stirred evenly and gently; concrete procedures of washing each time include: washing for 3 minutes at a water temperature of 40±3° C. and a water level of 13 cm without cooling down, where 20 g standard detergent powder as stipulated in GB/T8629-2001:7A is used; rinsing for the first time for 3 minutes at a water level of 13 cm; rinsing for the second time for 3 minutes at a water level of 13 cm, the dewatering time being 1 minute; rinsing for the third time for 2 minutes at a water level of 13 cm, the dewatering time being 6 minutes; and then drying the sample by using a tumble dryer.

Afterward, testing the thermal resistance value (signified by a Clo value) of the sample washed, and calculating a thermal resistance retention rate (%)=100×(the Clo value after washing)/(the Clo value before washing).

3 Embodiments and Comparative Example

Thermal insulation flocculus materials in various embodiments and the comparative example are prepared by using the foregoing raw materials, specifically as follows:

### Embodiment 1

Selecting 1.5 kg of the low-melting-point fiber 1, 3.5 kg of the non-low-melting-point fiber 1 and 5 kg of the non-low-melting-point fiber 2, and forming two multi-layer single fiber meshes having a grammage of 50 gsm by means of mixing-opening-carding-cross lapping (by using a scx26 type spray-bonded wadding production line purchased from Jiangsu Yingyang Nonwoven Machinery Co., Ltd.).

Selecting 2 kg of the low-melting-point fiber 1 and 8 kg of the non-low-melting-point fiber 2, and making them into a fiber ball having a particle size from 3 mm to 15 mm by using a ball forming mill (a HJZZM-100 type ball fiber machine purchased from Kunshan City, Hai Jin Machinery Co., Ltd.), serving as spherical fiber assemblies.

Evenly spreading the spherical fiber assemblies on a multi-layer single fiber mesh by a grammage of 100 gsm, and then spreading another multi-layer single fiber mesh thereon.

Spraying glue 1 on the external surface of the material, ensuring that the solid content of the glue 1 sprayed is 6 gsm.

Performing a thermal processing and setting treatment on the material (simultaneously drying the glue 1): drying for 8 minutes at 145° C., and obtaining the thermal insulation flocculus material having a grammage of 200 gsm as shown in FIG. 1.

### Embodiment 2

Selecting 1.5 kg of the low-melting-point fiber 2, 3.5 kg of the non-low-melting-point fiber 3 and 5 kg of the non-low-melting-point fiber 2, and forming two multi-layer single fiber meshes having a grammage of 20 gsm by means of mixing-opening-carding-cross lapping (by using a scx26 type spray-bonded wadding production line purchased from Jiangsu Yingyang Nonwoven Machinery Co., Ltd.).

Selecting 1 kg of the low-melting-point fiber 2 and 9 kg of the non-low-melting-point fiber 4, and making them into a fiber ball having a particle size from 3 mm to 15 mm by using a ball forming mill (a HJZZM-100 type ball fiber machine purchased from Kunshan City, Hai Jin Machinery Co., Ltd.), serving as spherical fiber assemblies.

Evenly spreading the spherical fiber assemblies on a multi-layer single fiber mesh by a grammage of 160 gsm, and then spreading another multi-layer single fiber mesh thereon.

Spraying glue 2 on the external surface of the material, ensuring that the solid content of the glue 2 sprayed is 4 gsm.

Performing a thermal processing and setting treatment on the material (simultaneously drying the glue 2): drying for 12 minutes at 135° C., and obtaining the thermal insulation flocculus material having a grammage of 200 gsm as shown in FIG. 1.

### Embodiment 3

Selecting 1.5 kg of the low-melting-point fiber 3, 3.5 kg of the non-low-melting-point fiber 1 and 5 kg of the non-low-melting-point fiber 2, and forming two multi-layer single fiber meshes having a grammage of 80 gsm by means of mixing-opening-carding-cross lapping (by using a scx26 type spray-bonded wadding production line purchased from Jiangsu Yingyang Nonwoven Machinery Co., Ltd.).

Selecting 2 kg of the low-melting-point fiber 3 and 8 kg of the non-low-melting-point fiber 2, and making them into a fiber ball having a particle size from 3 mm to 15 mm by using a ball forming mill (a HJZZM-100 type ball fiber machine purchased from Kunshan City, Hai Jin Machinery Co., Ltd.), serving as spherical fiber assemblies.

Evenly spreading the spherical fiber assemblies on a multi-layer single fiber mesh by a grammage of 40 gsm, and then spreading another multi-layer single fiber mesh thereon.

Spraying glue 3 on the external surface of the material, ensuring that the solid content of the glue 3 sprayed is 10 gsm.

Performing a thermal processing and setting treatment on the material (simultaneously drying the glue 3): drying for 10 minutes at 140° C., and obtaining the thermal insulation flocculus material having a grammage of 200 gsm as shown in FIG. 1.

### Comparative Example

Selecting 1.5 kg of the low-melting-point fiber 1, 3.5 kg of the non-low-melting-point fiber 1 and 5 kg of the non-low-melting-point fiber 2, and forming one multi-layer single fiber meshes having a grammage of 200 gsm by means of mixing-opening-carding-cross lapping (by using a scx26 type spray-bonded wadding production line purchased from Jiangsu Yingyang Nonwoven Machinery Co., Ltd.).

Spraying glue 2 on the external surface of the material, ensuring that the solid content of the glue 2 sprayed is 6 gsm.

Performing a thermal processing and setting treatment on the material (simultaneously drying the glue 2): drying for 8 minutes at 145° C., and obtaining the thermal insulation flocculus material having a grammage of 200 gsm.

4. Performance Test Results

Performance tests of the thermal insulation flocculus materials in various embodiments and the comparative example are conducted according to the foregoing performance test methods, and specific test results are as below:

1) Filling Power

The filling power of various thermal insulation flocculus materials is tested according to the foregoing methods, and the test results are as shown in FIG. 2.

It is clear that all values of filling power of thermal insulation flocculus materials in various embodiments of the present disclosure are above 140 m³/g, whereas a value of filling power of the thermal insulation flocculus material consisting purely of single fiber meshes is merely about 100 m³/g. This indicates that filling power of thermal insulation flocculus material may be apparently improved by adding spherical fiber assemblies.

2) Thermal Insulation Property

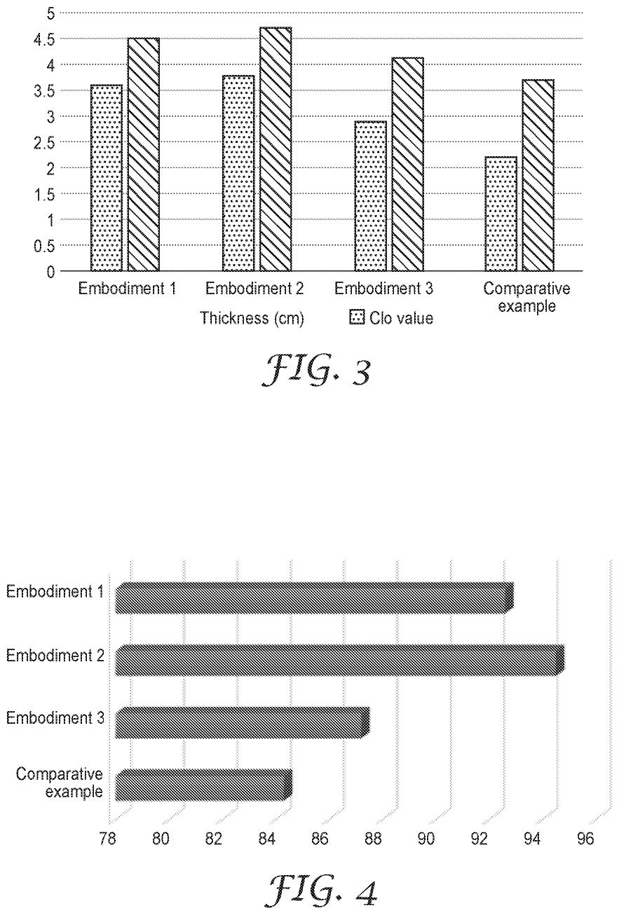

The thermal insulation property of various thermal insulation flocculus materials is tested according to the foregoing methods, and the test results are as shown in FIG. 3.

It is clear that in the case of the same grammage, thicknesses and Clo values of thermal insulation flocculus materials in various embodiments of the present disclosure are apparently higher than those of the thermal insulation flocculus material in the comparative example, and thus better thermal insulation property (thermogravimetric efficiency) is provided. This may be because in the case of the same grammage, a vacuum-packed spherical fiber assembly is larger than a single fiber mesh in thickness. Meanwhile, the above composite structure is advantageous to retaining more still air in the thermal insulation flocculus material to improve the thermal insulation property.

3) Compression-Resilience Property

The compression-resilience property of various thermal insulation flocculus materials is tested according to the foregoing methods, and the test results are as shown in FIG. 4. It is clear that the compression resilience ratios of thermal insulation flocculus materials in various embodiments of the present disclosure are apparently higher than the compression resilience ratio of the thermal insulation flocculus material in the comparative example. This indicates that the compression resilience ratio of the thermal insulation flocculus material may also be improved by adding the spherical fiber assemblies. This may be because a fiber ball has a more compact structure, and thus can better recover from deformation.

4) Wash Durability

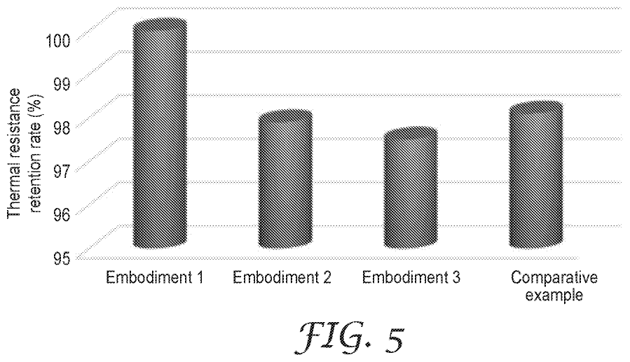

The wash durability of various thermal insulation flocculus materials is tested according to the foregoing methods, and the test results are as shown in FIG. 5. It is clear that after the thermal insulation flocculus material in Embodiment 1 of the present disclosure is washed, its thermal resistance retention rate is approximate to 100%, which indicates that it has excellent wash durability. Correspondingly, although thermal resistance retention rates of the thermal insulation flocculus materials in Embodiment 2 and Embodiment 3 of the present disclosure are slightly lower than the thermal resistance retention rate of the thermal insulation flocculus material in the comparative example, they are both above 97%. This indicates that the wash durability of the thermal insulation flocculus materials in the embodiments of the present disclosure is good, no apparent difference from the thermal insulation flocculus material consisting purely of single fiber meshes in thermal resistance retention rate, and thus being able to meet use requirements in most cases.

In conclusion, with respect to the existing thermal insulation flocculus material consisting purely of single fiber meshes, the thermal insulation flocculus material in embodiments of the present disclosure is greatly improved in filling power, thermal insulation property and compression-resilience property or the like by using spherical fiber assemblies. Furthermore, by adjusting the ratio of the single fiber meshes to the spherical fiber assemblies as well as structure and quantity or the like, the foregoing properties may be adjusted on a large scale, to meet requirements in different cases. Also, although the thermal insulation flocculus material in embodiments of the present disclosure includes spherical fiber assemblies, its wash durability is still excellent, at least equivalent to the thermal insulation flocculus material consisting purely of single fiber meshes. Thus it can be seen that the thermal insulation flocculus material in embodiments of the present disclosure has combination properties such as excellent filling power, thermal insulation property, compression-resilience property, and wash durability, etc.

It is to be understood that the foregoing implementation manners are merely exemplary implementation manners to describe the principle of the present disclosure. However, the present disclosure is not limited to this. To those of ordinary skill in the art, various modifications and improvements may be made without departing from the spirit and essence of the present disclosure, and these modifications and improvements are also deemed to be within the scope of protection of the present disclosure.

What is claimed is:

1. A thermal insulation flocculus material, comprising:
multiple overlapped single fiber meshes;
and
a spherical fiber assembly at least distributed between a part of adjacent single fiber meshes.

2. The thermal insulation flocculus material of claim 1, wherein
a weight ratio of the single fiber mesh to the spherical fiber assembly is ranged between about 20:80 and about 80:20.

3. The thermal insulation flocculus material of claim 2, wherein
the weight ratio of the single fiber mesh to the spherical fiber assembly is ranged between about 40:60 and about 60:40.

4. The thermal insulation flocculus material of claim 1, wherein
multiple adjacent single fiber meshes constitute a multi-layer single fiber mesh, wherein all the spherical fiber assemblies are distributed between adjacent multi-layer single fiber meshes; and
each of the multi-layer single fiber meshes has a grammage ranged between about 20 g/m² and about 150 g/m².

5. The thermal insulation flocculus material of claim 4, wherein
each of the multi-layer single fiber meshes has a grammage ranged between about 40 g/m² and about 100 g/m².

6. The thermal insulation flocculus material of claim 1, wherein
the spherical fiber assembly positioned between two adjacent single fiber meshes has a grammage ranged between about 20 g/m² and about 200 g/m².

7. The thermal insulation flocculus material of claim 6, wherein
the spherical fiber assembly positioned between two adjacent single fiber meshes has a grammage ranged between about 40 g/m² and about 160 g/m².

8. The thermal insulation flocculus material of claim 1, wherein
the spherical fiber assembly has a particle size ranged between about 3 mm and about 15 mm.

9. The thermal insulation flocculus material of claim 1, wherein
at least a part of fibers constituting the single fiber mesh are low-melting-point fibers; and
at least a part of fibers constituting the spherical fiber assembly are low-melting-point fibers.

10. The thermal insulation flocculus material of claim 9, wherein
a weight percentage of the low-melting-point fibers among the fibers constituting the single fiber mesh is ranged between about 5% and about 20%; and
a weight percentage of the low-melting-point fibers among the fibers constituting the spherical fiber assembly is ranged between about 5% and about 20%; and

11. The thermal insulation flocculus material of claim 9, wherein
a melting point of the low-melting-point fibers is ranged between about 100° C. and about 140° C.

12. The thermal insulation flocculus material of claim 9, wherein
the low-melting-point fibers have a length ranged between about 20 mm and about 90 mm.

13. The thermal insulation flocculus material of claim 9, wherein
the low-melting-point fibers have a fineness ranged between about 1.5 Denier and about 7 Denier.

14. The thermal insulation flocculus material of claim 9, wherein
other fibers excluding the low-melting-point fibers have a length ranged between about 15 mm and about 75 mm.

15. The thermal insulation flocculus material of claim 9, wherein
other fibers excluding the low-melting-point fibers have a fineness ranged between about 0.2 Denier and about 15 Denier.

16. The thermal insulation flocculus material of claim 1, wherein
the thermal insulation flocculus material is subjected to thermal processing and setting treatment.

17. The thermal insulation flocculus material of claim 1, wherein
the thermal insulation flocculus material is subjected to surface glue spraying treatment.

18. A method for preparing thermal insulation flocculus material, comprising:
applying a spherical fiber assembly to a first single fiber mesh; and
compositing at least a second single fiber mesh onto the first single fiber mesh to which the spherical fiber assembly is applied.

19. A thermal insulation product, comprising:
a cladding body, configured to define enclosed internal space; and
thermal insulation flocculus material disposed in the enclosed internal space as defined by the cladding body, wherein the thermal insulation flocculus material comprises multiple overlapped single fiber meshes, and a spherical fiber assembly at least distributed between a part of adjacent single fiber meshes.

20. The thermal insulation product of claim 19, wherein
the thermal insulation product is any one of shoes, a cap, clothes, a pillow, a quilt, a mattress and a sleeping bag.
